(19) United States
(12) Patent Application Publication
(10) Pub. No.: US 2014/0086531 A1
(43) Pub. Date: Mar. 27, 2014

(54) OPTICAL FILTER HAVING SINGLE REFLECTING TOTAL INTERNAL REFLECTION ECHELLE GRATING FILTER AND OPTICAL WAVEGUIDE DEVICE INCLUDING THE SAME

(71) Applicant: Electronics and Telecommunications Research Institute, (US)

(72) Inventors: Sahnggi PARK, Daejeon (KR); Sang Gi KIM, Daejeon (KR); Jaegyu PARK, Daejeon (KR); Gyungock KIM, Daejeon (KR)

(73) Assignee: Electronics and Telecommunications Research Institute, Daejeon (KR)

(21) Appl. No.: 13/794,619

(22) Filed: Mar. 11, 2013

(30) Foreign Application Priority Data
Sep. 24, 2012 (KR) 10-2012-0105914

(51) Int. Cl. G02B 6/34

(52) U.S. Cl. CPC G02B 6/34
USPC 385/37

(57) ABSTRACT

An optical filter of the inventive concept includes a slab waveguide disposed on a substrate, an input guide gate and an output guide gate spaced apart from each other in the slab waveguide, and an echelle grating filter disposed in the slab waveguide. The echelle grating filter has curvature and extends in a first direction. The echelle grating filter has gratings of sawtooth shape on one surface thereof. Light inputted through the input guide gate is totally reflected at the echelle grating filter by one reflecting process.

### CROSS-REFERENCE TO RELATED APPLICATIONS

This U.S. non-provisional patent application claims priority under 35 U.S.C. §119 to Korean Patent Application No. 10-2012-0105914, filed on Sep. 24, 2012, the entirety of which is incorporated by reference herein.

### BACKGROUND

The inventive concept relates to optical devices and, more particularly, to an optical filter having an echelle grating filter and an optical waveguide device including the same.

MUX/DEMUX wavelength division multiplexing (WDM) devices are widely used in an optical communication field. An arrayed waveguide grating (AWG) technique and a silicon photonics technique converting an electrical signal into an optical signal are highlighted for the MUX/DEMUX WDM devices. Thus, various researches are conducted for a ring resonator and/or and an echelle grating device. Particularly, echelle grating filters may reduce a wavelength error caused by a manufacturing method because of their structural characteristics as compared with the ring resonator and the AWG. Thus, various researches are conducted for integrating the echelle grating filters in a silicon photonics chip. The echelle grating filter has a reflection cross section reflecting light which is disposed in a slab waveguide. Generally, the echelle grating filter has a total internal reflection (TIR) cross section using a coated metal or difference between refractive indexes. However, if the echelle grating filter uses the coated metal, manufacturing processes of the echelle grating filter may be complicated and impurity-contamination may be caused by the metal. If the echelle grating filter uses the difference between refractive indexes for the TIR, the echelle grating filter may require two reflection cross sections (e.g., a retro-reflector). In this case, light is reflected twice and then is returned at an angle equal an incident angle. In the case that the light is reflected twice, loss of the light by reflection doubly increases. Additionally, manufacturing processes and a design of the echelle grating filter may be complicated.

### SUMMARY

Embodiments of the inventive concept may provide an optical filter with improved reliability and an optical waveguide device including the same.

In one aspect, an optical filter may include: a slab waveguide disposed on a substrate; an input guide gate and an output guide gate spaced apart from each other in the slab waveguide; and an echelle grating filter disposed in the slab waveguide. The echelle grating filter may have curvature and may extend in a first direction. The echelle grating filter may have gratings of sawtooth shape on one surface thereof. Light inputted through the input guide gate may be totally reflected at the echelle grating filter by one reflecting process.

In an embodiment, the input and output guide gates may be disposed toward the echelle grating filter.

In an embodiment, the inputted light may be resolved into lights respectively having wavelength-bands different from each other by the echelle grating filter; the output guide gate may include a plurality of output guide gates; and the resolved lights may reach the plurality of output guide gates, respectively.

In an embodiment, the inputted light may be incident on the echelle grating filter at an incident angle greater than 26 degrees and less than 90 degrees.

In an embodiment, constructive interference of the totally reflected light may occur by the gratings of the sawtooth shape.

In an embodiment, a distance between the gratings of the sawtooth shape may have a range of about 3 μm to about 100 μm.

In an embodiment, a thickness of the slab waveguide may have a range of about 200 nm to about 5 μm.

In an embodiment, the optical filter may further include: a cladding layer covering the slab waveguide. The cladding layer may include a silicon oxide (SiO₂) layer, a silicon nitride (SiN) layer, or air.

In another aspect, an optical waveguide device may include: an input waveguide part including an input waveguide; an output waveguide part including an output waveguide; and a filter part disposed between the input and output waveguide parts. The filter part may include: an echelle grating filter disposed in a slab waveguide; an input guide gate disposed in the slab waveguide and connected to the input waveguide; and an output guide gate disposed in the slab waveguide and connected to the output waveguide. The echelle grating filter may extend in a first direction and have curvature. The echelle grating filter may have gratings of sawtooth shape. An angle formed by the gratings of the sawtooth shape may be greater than 90 degrees and less than 180 degrees.

In an embodiment, the output waveguide may include a plurality of output waveguides; and the output guide gate may include a plurality of output guide gates.

In an embodiment, the input and output guide gates may be disposed toward the echelle grating filter.

In an embodiment, the input waveguide and the output waveguide may extend in the first direction.

In an embodiment, the input guide gate may be disposed toward a center of the echelle grating filter.

In an embodiment, the input and output waveguides, the input and output guide gates and the slab waveguide may include the same material.

In an embodiment, the input and output waveguides, the input and output guide gates and the slab waveguide may include silicon.

In an embodiment, the optical waveguide device may further include: a cladding layer covering the input waveguide part, the output waveguide part, and the filter part.

In an embodiment, the cladding layer and the echelle grating filter may include the same material.

In an embodiment, the cladding layer and the echelle grating filter may include silicon oxide.

### BRIEF DESCRIPTION OF THE DRAWINGS

The inventive concept will become more apparent in view of the attached drawings and accompanying detailed description.

FIG. 1 is a plan view illustrating an optical waveguide device including an echelle grating filter according to some embodiments of the inventive concept;

FIGS. 2A, 2B, 2C, 2D, 2E, and 2F are cross-sectional views taken lines I-I′, II-II′, III-III′, IV-IV′, V-V′, and VI-VI′ of FIG. 1, respectively;

FIG. 3 is a plan view illustrating an echelle grating filter according to some embodiments of the inventive concept;

FIG. 4 is a plan view illustrating a general echelle grating filter;

FIGS. 5A, 5B, and 5C are schematic diagrams illustrating a diffraction equation of an echelle grating filter;

FIG. 6 is a plan view illustrating a position of an input waveguide and a direction of an input guide gate according to some embodiments of the inventive concept;

FIG. 7 is a plan view illustrating an optical waveguide device according to other embodiments of the inventive concept;

FIG. 8 is a scanning electron microscope (SEM) photograph illustrating an echelle grating filter manufactured according to some embodiments of the inventive concept; and

FIG. 9 is a transmission spectrum of an 8-channel optical waveguide device manufactured according to some embodiments of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

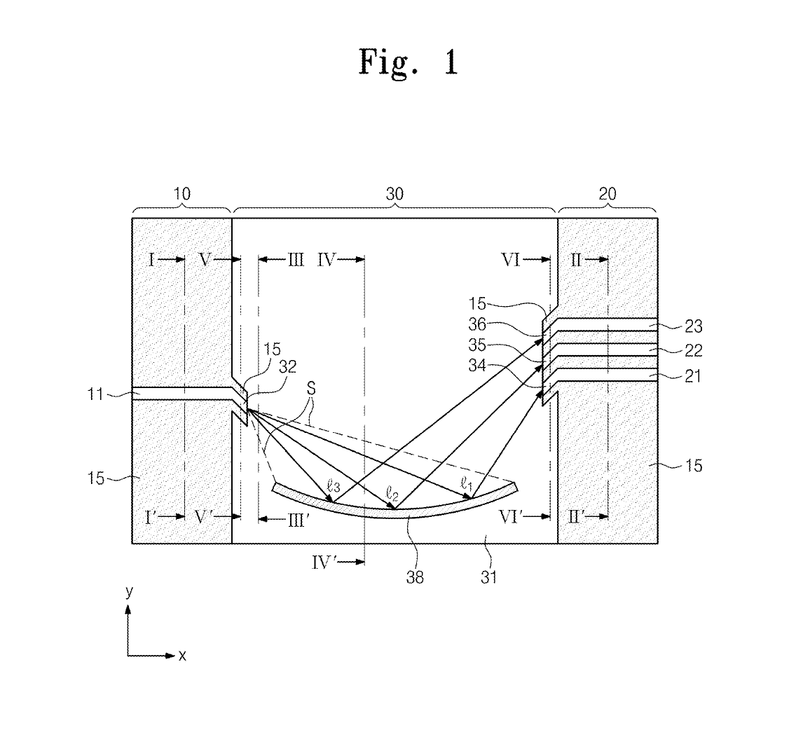

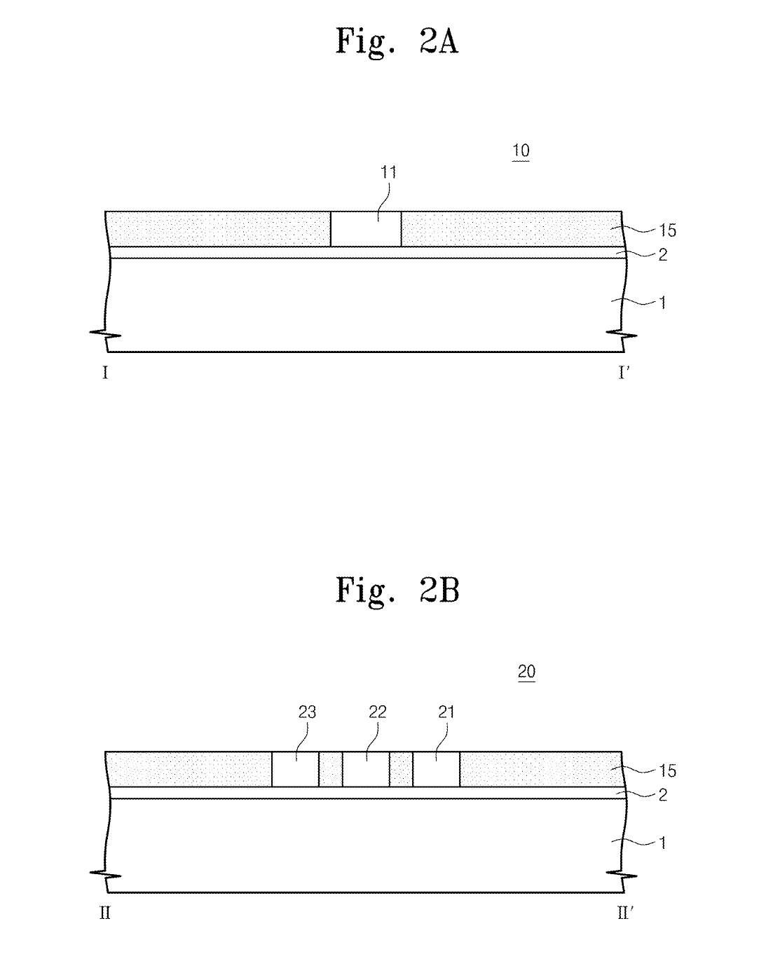

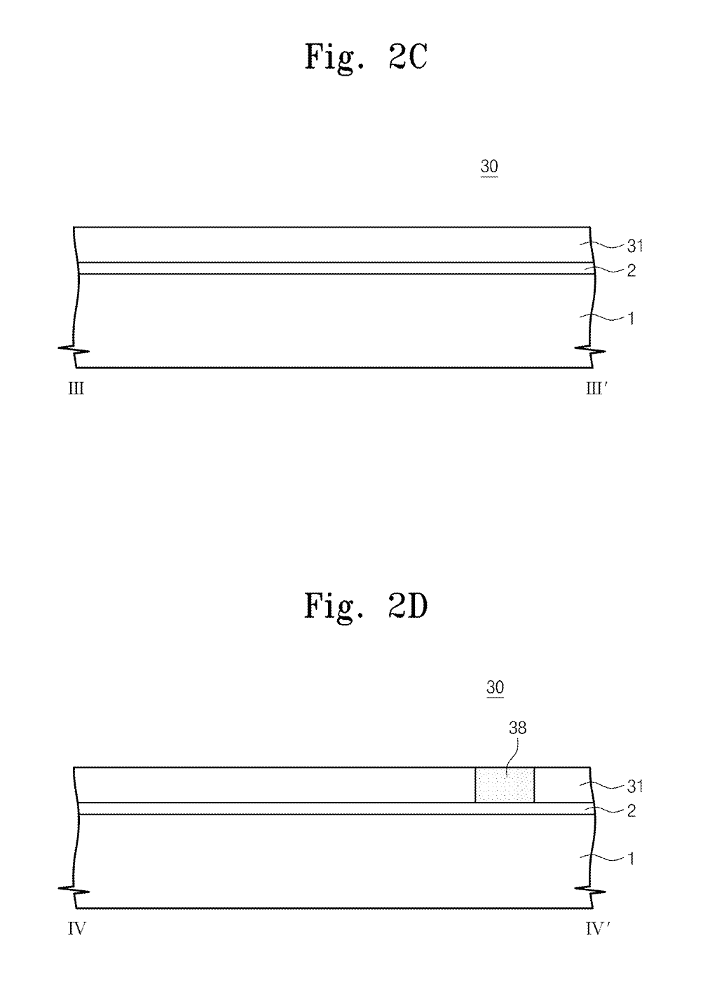

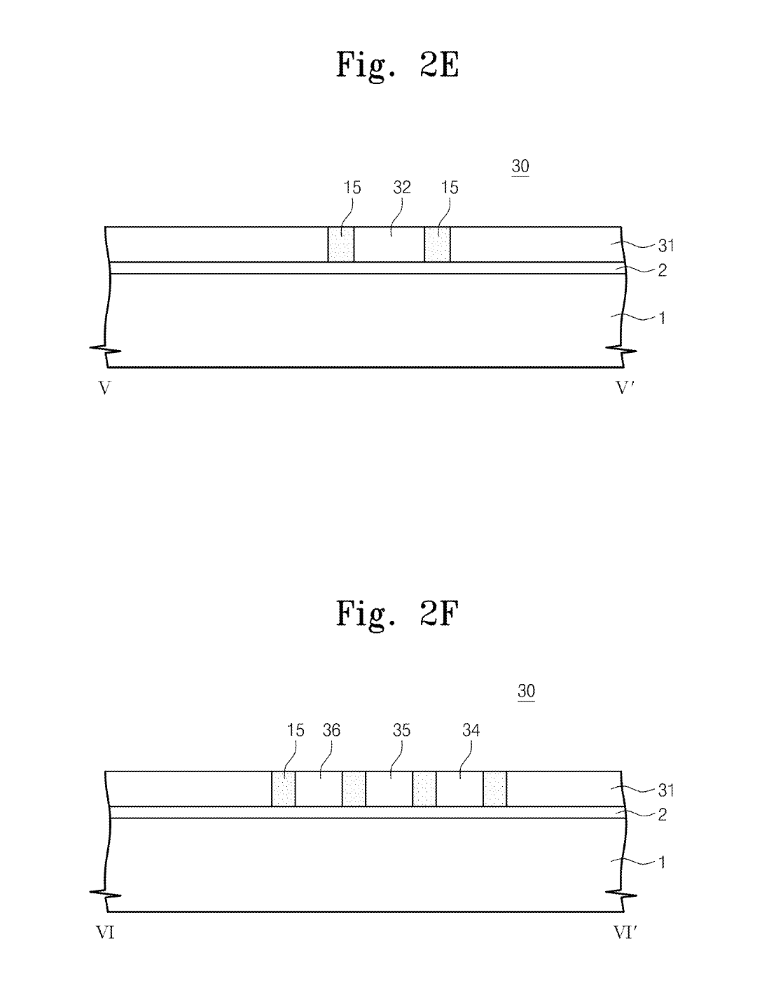

FIG. 1 is a plan view illustrating an optical waveguide device including an echelle grating filter according to some embodiments of the inventive concept. FIGS. 2A, 2B, 2C, 2D, 2E, and 2F are cross-sectional views taken lines I-I′, II-II′, III-III′, IV-IV′, V-V′, and VI-VI′ of FIG. 1, respectively. For the purpose of ease and convenience in explanation, a cladding portion of a cladding layer 15, which totally covers an optical waveguide device, is omitted in the plan view and the cross-sectional views of FIGS. 1 and 2A to 2F.

Referring to FIG. 1, a waveguide device according to some embodiments includes an input waveguide part 10, an output waveguide part 20, and a filter part 30 disposed between the input waveguide part 10 and the output waveguide part 20.

Referring to FIGS. 1 and 2A, the input waveguide part 10 may include an input waveguide 11 disposed on a semiconductor substrate 1 and a cladding layer 15 covering the input waveguide 11. The semiconductor substrate 1 may be a substrate including a semiconductor material. For example, the semiconductor substrate 1 may be a silicon substrate, a germanium substrate, or a silicon-on-insulator (SOI) substrate. In an embodiment, if the semiconductor substrate 1 is the SOI substrate, the semiconductor substrate 1 may further include an insulating layer 2 on the semiconductor substrate 1 as illustrated in FIG. 2A. For example, the insulating layer 2 may include a silicon oxide layer. In this case, the insulating layer 2 may function as a lower cladding layer. The input waveguide 11 may be formed of a material having a refractive index different from those of the cladding layer 15 and the insulating layer 2. In an embodiment, the input waveguide 11 may be formed of the same material (e.g., silicon (Si) as the semiconductor substrate 1, and the cladding layer 15 may be formed of the same material (e.g., silicon oxide (SiO₂)) as the insulating layer 2. In other embodiments, the cladding layer 15 may include silicon nitride or air.

In some embodiments, a silicon layer may be formed on a semiconductor substrate 1 or the insulating layer 2, and then the silicon layer may be patterned to form the input waveguide 11. Thereafter, the cladding layer 15 may be formed on an entire surface of the semiconductor substrate 1 so as to cover the input waveguide 11. The cladding layer 15 may be formed to cover a top surface of the input waveguide 11. However, this is omitted in FIG. 2A for the purposes of ease and convenience in explanation. In the present embodiment, one input waveguide 11 is illustrated in FIGS. 1 and 2A. However, the inventive concept is not limited thereto. In other embodiments, a plurality of input waveguides 11 may be provided on the semiconductor substrate 1.

The input waveguide 11 may function as a path through which light is transmitted. The input waveguide 11 may extend in a first direction (e.g., an x-axis direction of FIG. 1). Thus, the light may be transmitted along the input waveguide 11 extending in the first direction.

Referring to FIGS. 1 and 2B, the output waveguide part 20 may include a plurality of output waveguides 21, 22, and 23 disposed on the semiconductor substrate 1 or on the insulating layer 2, and the cladding layer 15 covering the output waveguides 21, 22, and 23. A silicon layer may be formed on the semiconductor substrate 1 or the insulating layer 2 and then be patterned to form the output waveguides 21, 22, and 23. Thereafter, the cladding layer 15 may be formed on an entire surface of the semiconductor substrate 1 so as to cover the output waveguides 21, 22, and 23. The cladding layer 15 may cover top surfaces of the output waveguides 21, 22, and 23. However, this feature is not illustrated in FIG. 2A for the purpose of ease and convenience in explanation.

Like the input waveguide 11, the output waveguides 21, 22, and 23 are formed of a material having a refractive index different from those of the cladding layer 15 and the insulating layer 2. Thus, the output waveguides 21, 22, and 23 may function as paths through which light is transmitted. The number of the output waveguides 21, 22, and 23 may be greater than the number of the input waveguide 11. Three output waveguides 21, 22, and 23 are illustrated in FIGS. 1 and 2B. However, the inventive concept is not limited thereto. In an embodiment, eight output waveguides and one input waveguide may constitute one group, so that an 8-channel optical waveguide device may be realized. Light inputted through the input waveguide 11 may be resolved into lights respectively having wavelength-bands different from each other by the filter part 30 and then the resolved lights may be transmitted into the output waveguides 21, 22, and 23.

Referring to FIG. 1, the filter part 30 is disposed between the input waveguide part 10 and the output waveguide part 20. The filter part 30 may include a slab waveguide 31 and an echelle grating filter 38 disposed in the slab waveguide 31. The slab waveguide 31 may extend in the first direction (e.g., the x-axis direction) and a second direction (e.g., a y-axis direction). In other words, the slab waveguide 31 may have a plane-shape. Referring to FIGS. 1 and 2C, the slab waveguide 31 may be formed of the same material (e.g., silicon) as the semiconductor substrate 1. The cladding layer 15 may entirely cover the slab waveguide 31. However, this feature is not illustrated in FIG. 2C for the purpose of ease and convenience in explanation. The slab waveguide 31 may function as a path through which light is transmitted.

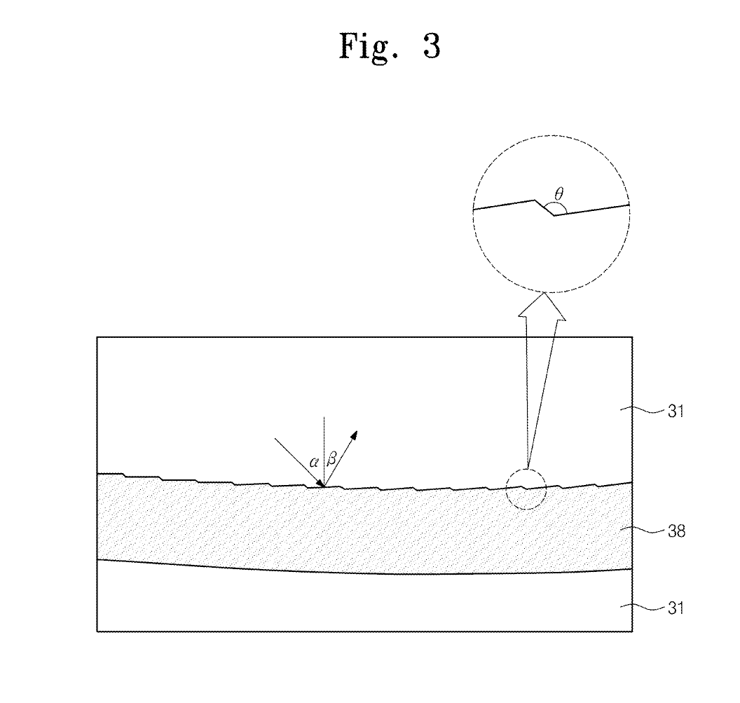

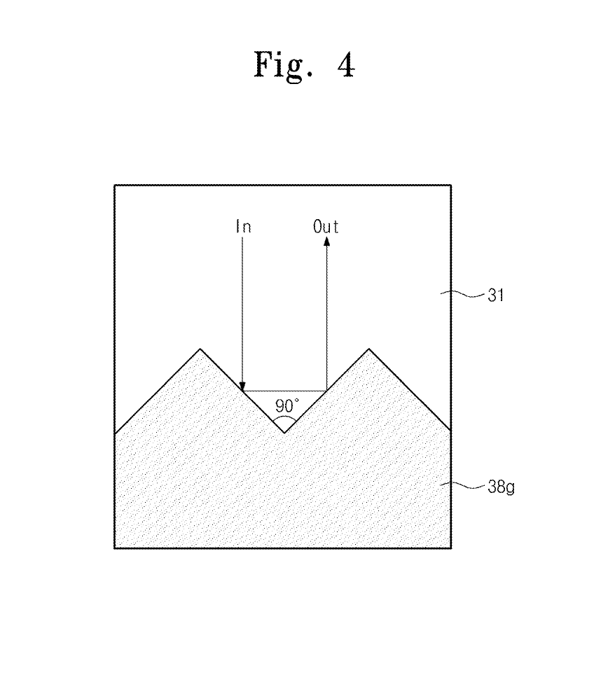

Referring to FIGS. 1 and 2D, the echelle grating filter 38 may be disposed at a side of a virtual center line of the slab waveguide 31 extending in the first direction (e.g., the x-axis direction) in a plan view. For example, the echelle grating filter 38 may be disposed to be lower than the input and output waveguides 11, 21, 22, and 23 in a plan view as illustrated in FIG. 1. The echelle grating filter 38 may extend in the first direction and have predetermined curvature. The slab waveguide 31 on the insulating layer 2 may be patterned to form an opening exposing the insulating layer 2 and then an insulating layer may be deposited to fill the opening. The insulating layer in the opening may correspond to the echelle grating filter 38. For example, the echelle grating filter 38 may be formed of the same material as the cladding layer 15. For example, the echelle grating filter 38 may be formed of silicon oxide. At least one surface of the echelle grating filter 38 has gratings of a sawtooth shape. The light transmitted through the input waveguide 11 may be totally reflected by the gratings of the sawtooth shape and then be transmitted into the output waveguides 21, 22, and 23. This will be mentioned later in more detail with reference to FIGS. 3 and 4.

Referring to FIGS. 1 and 2E, the filter part 30 may further include an input guide gate 32 disposed in the slab waveguide 31. The slab waveguide 31 may be patterned to form openings defining the input guide gate 32. The openings may expose the insulating layer 2. The openings at both sides of the input guide gate 32 may be filled with the cladding layer 15. The input guide gate 32 may be in contact with the input waveguide 11 and be disposed toward the echelle grating filter 38. Since the input guide gate 32 is in contact with the input waveguide 11, the light inputted through the input waveguide 11 may be transmitted along the input guide gate 32. Additionally, since the input guide gate 32 is disposed toward the echelle grating filter 38, the light passing through the input guide gate 32 may be spreading in the slab waveguide 31 and then be inputted to the echelle grating filter 38 extending in the first direction. At this time, the direction of the input guide gate 32 and a length of the echelle grating filter 38 may be controlled in order that all of the light is inputted to the echelle grating filter 38.

Referring to FIGS. 1 and 2F, the filter part 30 may further include output guide gates 34, 35, and 36 disposed in the slab waveguide 31. The slab waveguide 31 may be patterned to form openings defining the output guide gates 34, 35, and 36. The openings may expose the insulating layer 2. The cladding layer 15 may fill the openings defining the output guide gates 34, 35, and 36. The output guide gates 34, 35, and 36 may be in contact with the output waveguides 21, 22, 23, respectively. The output guide gates 34, 35, and 36 may be disposed toward the echelle grating filter 38. Since the output guide gates 34, 35, and 36 are in contact with the output waveguides 21, 22, and 23, the light totally reflected by the echelle grating filter 38 may be transmitted through the output guide gates 34, 35, and 36 and then be outputted through the output waveguides 21, 22, and 23.

Referring to FIG. 1, the input waveguide part 10, the output waveguide part 20, and the filter part 30 share the semiconductor substrate 1 and the insulating layer 2. In other words, the input waveguide part 10, the output waveguide part 20, and the filter part 30 may be formed on one semiconductor substrate 1 and one insulating layer 2 by the same patterning process at the same time. In more detail, the input and output waveguides 11, 21, 22, and 23, the input and output guide gates 32, 34, 35, and 36, and the slab waveguide 31 may be formed of the same material (e.g., silicon) and may be formed by the patterning process at the same time. The cladding layer 15 and the echelle grating filter 38 may be formed of the same material (e.g., silicon oxide) and be formed by a deposition process at the same time.

While light inputted to the echelle grating filter 38 is totally reflected, the echelle grating filter 38 may resolve the inputted light into lights of which wavelength-bands are different from each other. The resolved lights may be transmitted into the output guide gates 34, 35, and 36 and then be outputted through the output waveguides 21, 22, and 23, respectively. Thus, the plurality of output waveguides 21, 22, and 23 may be provided in the optical waveguide device. The output waveguides 21, 22, and 23 may output the resolved lights of the different wavelength-bands. This will be described in more detail below.

For example, the light inputted through the input waveguide 11 may include mixed lights l₁, l₂, and l₃ having various wavelength-bands. The inputted light may reach the slab waveguide 31 through the input guide gate 32. The inputted light including the lights l₁, l₂, and l₃ are spreading along the slab waveguide 31. At this time, a spreading range S of the inputted light including the lights l₁, l₂, and l₃ may be designed by controlling a position of the input waveguide 11, a direction of the input guide gate 32, and/or a length of the echelle grating filter 38 in order that an entire inputted light including the lights l₁, l₂, and l₃ are inputted in the echelle grating filter 38. The inputted light may be totally reflected by the echelle grating filter 38 having the predetermined curvature and then may be resolved into the lights l₁, l₂, and l₃ according to their wavelength-bands. The resolved lights l₁, l₂, and l₃ may reach the output guide gates 34, 35, and 36 and then may be transmitted through the output waveguides 21, 22, and 23, respectively. As a result, the lights l₁, l₂, and l₃ may be resolved by the slab waveguide 31 and the echelle grating 38.

FIG. 3 is a plan view illustrating an echelle grating filter according to some embodiments of the inventive concept.

Referring to FIG. 3, the echelle grating filter 38 may extend in the first direction in the slab waveguide 31 and may have the predetermined curvature. The curvature of the echelle grating filter 38 may be suitably controlled so that the light inputted from the input waveguide 11 may be totally reflected by the echelle grating filter 38 and then may reach the output waveguides 21, 22, and 23. At least one surface of the echelle grating filter 38 has the gratings of the sawtooth shape. In this case, the light is incident on and is reflected by the one surface of the echelle grating filter 38. Several tens through hundreds gratings of the sawtooth shape may be disposed on the one surface of the echelle grating filter 38. The light inputted through the input waveguide 11 of FIG. 1 and the input guide gate 32 of FIG. 1 may reach the echelle grating filter 38 at an incident angle α. The inputted light is totally reflected by the echelle grating filter 38 at a reflection angle β, and then the reflected lights may be outputted through the slab waveguide 31, the output guide gates 34, 35, and 36 of FIG. 1 and the output waveguides 21, 22, and 23 of FIG. 1. At this time, the inputted light may be totally reflected at the gratings of the sawtooth shape of the echelle grating filter 38 through one reflecting process.

FIG. 4 is a plan view illustrating an echelle grating filter totally reflecting light through two reflecting processes according to a general technique.

According to a general technique with reference to FIG. 4, light inputted along an input waveguide may be vertically incident on an echelle grating filter 38g. The incident light may be totally reflected by echelle gratings meeting at right angles to each other through two reflecting processes and then the light may be outputted in a direction parallel to the incident direction. In this case, loss of the light may increase by the two reflecting processes and it may be difficult to manufacture the echelle gratings meeting at right angles. On the contrary, in the optical waveguide device according to the inventive concept, an incident angle within a range of total-reflection critical angle may be formed by the input waveguide 11 of FIG. 1 and the input guide gate 32 of FIG. 1, and the inputted light may be totally reflected by the echelle grating filter 38 through the one reflecting process. Thus, the optical waveguide device with high reliability may be provided.

In more detail, referring to FIG. 3, the light may be incident on the echelle grating filter 38 at an incident angle greater than 26 degrees and less than 90 degrees. In an embodiment of the inventive concept, if the slab waveguide 31 is formed of silicon and the echelle grating filter 38 is formed of silicon oxide, an effective refractive index (n_{eff}) of a transverse electric mode (TE mode) of the slab waveguide 31 is 2.83 (wherein the thickness of the slab waveguide 31 is 220 nm) and a refractive index of silicon oxide of the echelle grating filter 38 is 1.45. In this case, the total reflection critical angle (q_{c}) is 30.82 degrees (i.e., sin q_{c}=1.45/2.83). In other words, the total reflection occurs in the condition that each of the incident angle α and the refection angle β is greater than 30.82 degrees and is less than 90 degrees (30.82 degrees<α, β<90 degrees). Thus, the position of the input waveguide 11 of FIG. 1, the direction of the input guide gate 32 of FIG. 1, and the length of the echelle grating filter 38 are controlled in order that each of the incident angle α and the refection angle β is greater than 30.82 degrees and is less than 90 degrees (30.82 degrees<α, β<90 degrees). As a result, the inputted light may be totally reflected at the echelle grating filter 38 through the one reflecting process, and then the reflected and resolved lights may be outputted through the output guide gates 34, 35, and 36 of FIG. 1 and the output waveguides 21, 22, and 23 of FIG. 1. An angle θ formed by the gratings of the sawtooth shape may be greater than 90 degrees and less than 180 degrees. The thickness of the slab waveguide 31 may have a range of about 200 nm (nanometers) to about 5 μm (micrometers). In another embodiment, if the thickness of the slab waveguide 31 is 300 nm, the effective refractive index (n_{eff}) of the TE mode of the slab waveguide 31 is 3.1, and the total reflection critical angle is 27.9 degrees.

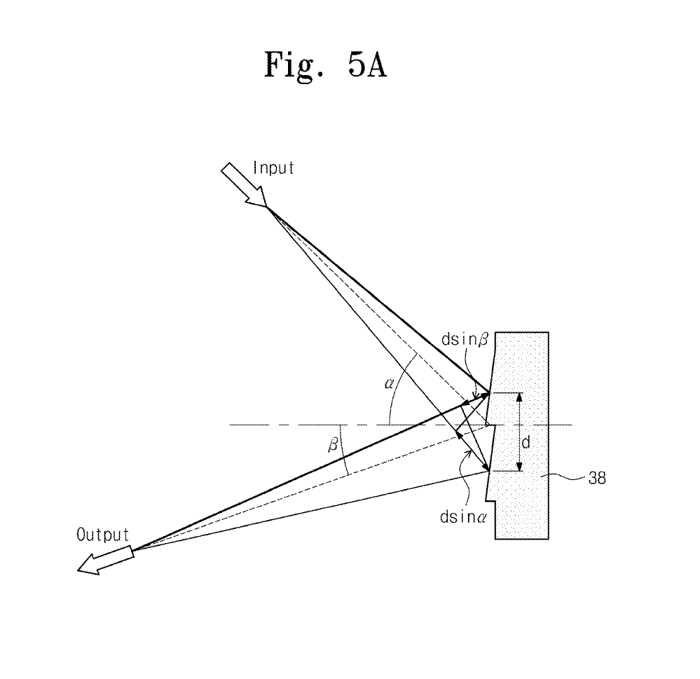

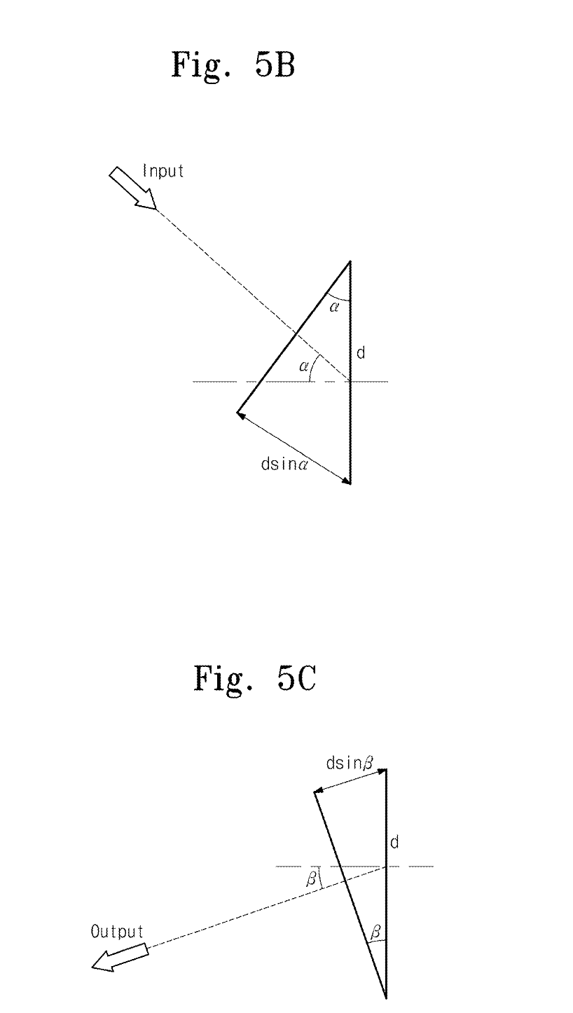

FIGS. 5A, 5B, and 5C are schematic diagrams illustrating a diffraction equation of an echelle grating filter.

Referring to FIGS. 5A, 5B, and 5C, the gratings of sawtooth shape in the echelle grating filter 38 may cause path difference between lights reaching positions adjacent to each other for performing a filter function. This will be described in more detail below.

FIG. 5A illustrates a path of the incident light and a path of reflection light at two echelle gratings adjacent to each other where a reference incident angle α and a reference reflection angle β are represented using dot lines. A distance between the gratings of the sawtooth shape is defined as a reference designator and the path difference between two full lines is defined as a reference designator ‘Dz’. The path difference Dz is expressed by an equation of ‘Dz=d×sin α−d×sin β’. Here, constructive interference occurs under the condition that the path difference Dz is equal to m×λ (where ‘m’ is an integer and is defined as an order of diffraction, ‘λ’ is defined as a wavelength of the incident light). A diffraction equation is expressed by an equation of ‘n_{eff}×d×(sin α−sin β)=m×λ’. In other words, if the path difference between two lights is an integer multiple, the intensity of the light may increase by the effective refractive index (n_{eff}) of the slab waveguide 31. The intensity of the outputted light through the output waveguides 21, 22, and 23 may increase by the constructive interference of adjacent lights in a specific wavelength-band. The distance d between the gratings of the sawtooth shape may have a range of about 3 μm to about 100 μm.

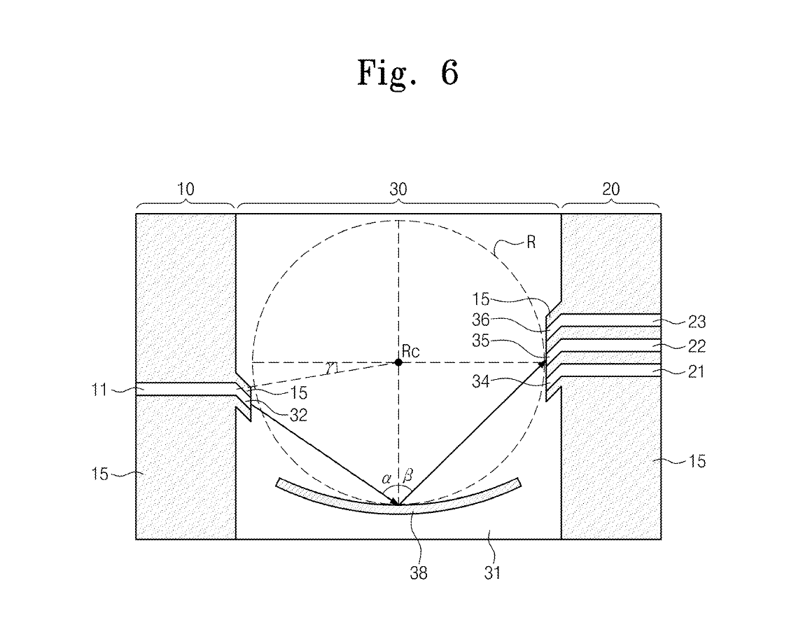

FIG. 6 is a plan view illustrating a position of an input waveguide and a direction of an input guide gate according to some embodiments of the inventive concept.

Referring to FIG. 6, the echelle grating filter 38 in the slab waveguide 31 may be disposed to be lower than the input waveguide 11 and the output waveguides 21, 22, and 23 in a plan view. The echelle grating filter 38 has predetermined curvature. In an embodiment, a Rowland circle R using the curvature of the echelle grating filter 38 as a diameter may be drawn to be in contact with the echelle grating filter 38, and the input and out waveguides 11, 23 and 21 may be disposed on the line of Roland circle.

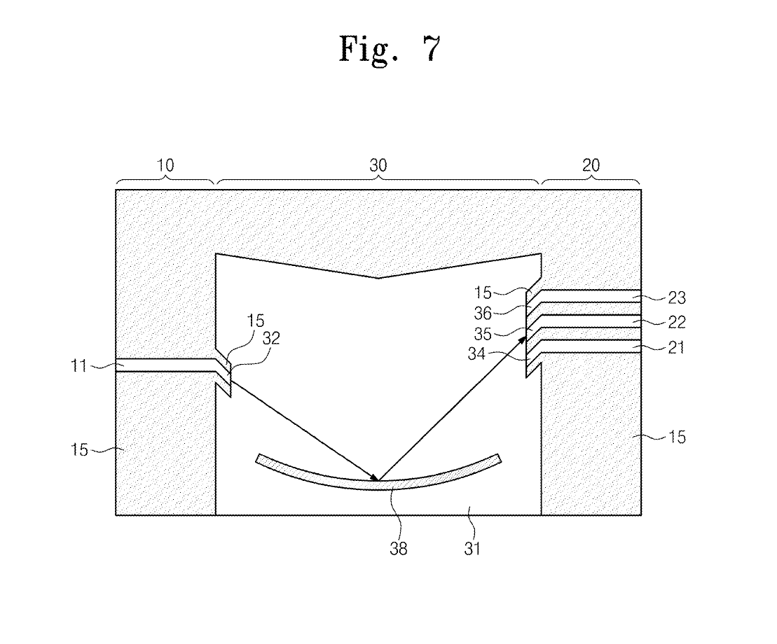

FIG. 7 is a plan view illustrating an optical waveguide device according to other embodiments of the inventive concept.

Referring to FIG. 7, in a plan view, an upper portion of the slab waveguide 31 may be disposed to higher than the input and output guide gates 32, 33, 34, and 35. The upper portion of the slab waveguide 31 in a plan view may be removed. In other words, the input and output guide gates 32, 34, 35, and 36 may be disposed toward the echelle grating filter 38 disposed in a side portion of the slab waveguide 31, such that a lower portion of the slab waveguide 31 lower than the guide gates 32, 34, 35, and 36 in a plan view may perform the function transmitting the light. Thus, the upper portion of the slab waveguide 31 with respect to the guide gates 32, 34, and 36 may be removed in a plan view. However, the inventive concept is not limited thereto.

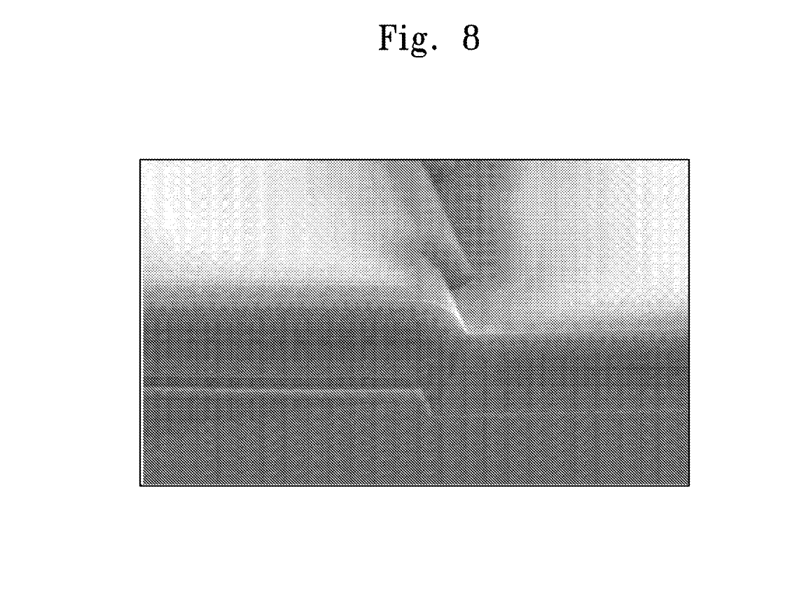

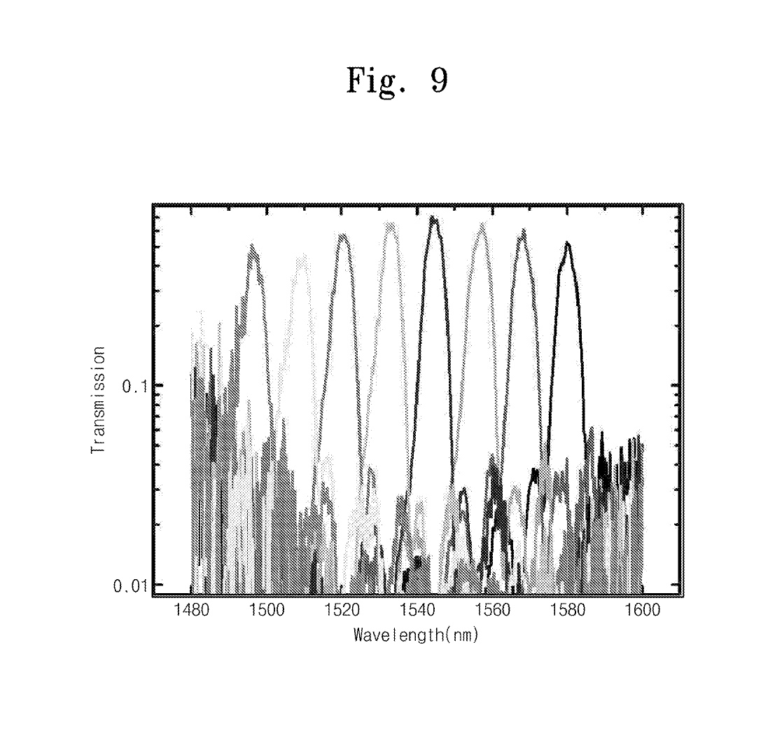

FIG. 8 is a scanning electron microscope (SEM) photograph illustrating an echelle grating filter manufactured according to some embodiments of the inventive concept, and FIG. 9 is a transmission spectrum of an 8-channel optical waveguide device manufactured according to some embodiments of the inventive concept.

FIG. 8 shows a cross section of the echelle grating filter in the slab waveguide disposed on the semiconductor substrate. In the present embodiment, the echelle grating filter has a several tens to hundreds gratings of the sawtooth shape. Referring to FIG. 9, an 8-channel optical waveguide device manufactured according to some embodiments has one input waveguide and eight output waveguides. In other words, light inputted from the one input waveguide may be resolved into lights of different wavelength-bands by the slab waveguide and the echelle grating filter mentioned above, such that the resolved lights may be outputted through the eight output waveguides, respectively. Thus, as illustrated in FIG. 9, a spectrum distribution has regions separated from each other according to wavelength-bands. In the present embodiment, the thickness of the slab waveguide is 220 nm, the curvature of the echelle grating filter is 2 mm, and the distance between two gratings of the sawtooth shape adjacent to each other is 21.9 μm. The incident angle is 50 degrees at the center of the echelle grating filter. The reflection angle is 40 degrees at the center of the echelle grating filter. The order of the diffraction is 5. The number of the channel is 8, and a wavelength space of each of the channels is 11.9 nm. An insertion loss is 1.5 dB, and a crosstalk between the channels adjacent to each other is 18 dB.

According to embodiments of the inventive concept, the filter part is provided between the input and out waveguides. The filter part includes the echelle grating filter disposed in the slab waveguide. The filter part resolve the light inputted from the input waveguide into the lights of which the wavelength-bands are different from each other. Additionally, the filter part may travel the resolved lights to the output waveguides. The filter part has the input guide gate contacting the input waveguide, and the input guide gate is disposed toward the echelle grating filter. The input guide gate is disposed to face the echelle grating filter in order that the inputted light is totally reflected at the echelle grating filter through one reflecting process. Thus, loss of the light may be reduced.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. An optical filter comprising:
a slab waveguide disposed on a substrate;
an input guide gate and an output guide gate spaced apart from each other in the slab waveguide; and
an echelle grating filter disposed in the slab waveguide,
wherein the echelle grating filter has curvature and extends in a first direction;
wherein the echelle grating filter has gratings of sawtooth shape on one surface thereof; and
wherein light inputted through the input guide gate is totally reflected at the echelle grating filter by one reflecting process.

2. The optical filter of claim 1, wherein the input and output guide gates are disposed toward the echelle grating filter.

3. The optical filter of claim 1, wherein the inputted light is resolved into lights respectively having wavelength-bands different from each other by the echelle grating filter;
wherein the output guide gate includes a plurality of output guide gates; and
wherein the resolved lights reach the plurality of output guide gates, respectively.

4. The optical filter of claim 1, wherein the inputted light is incident on the echelle grating filter at an incident angle greater than 26 degrees and less than 90 degrees.

5. The optical filter of claim 1, wherein constructive interference of the totally reflected light occurs by the gratings of the sawtooth shape.

6. The optical filter of claim 1, wherein a distance between the gratings of the sawtooth shape has a range of about 3 μm to about 100 μm

7. The optical filter of claim 1, wherein a thickness of the slab waveguide has a range of about 200 nm to about 5 μm

8. The optical filter of claim 1, further comprising:
a cladding layer covering the slab waveguide,
wherein the cladding layer includes a silicon oxide (SiO₂) layer, a silicon nitride (SiN) layer, or air.

9. An optical waveguide device comprising:
an input waveguide part including an input waveguide;
an output waveguide part including an output waveguide; and
a filter part disposed between the input and output waveguide parts,
wherein the filter part comprises: an echelle grating filter disposed in a slab waveguide; an input guide gate disposed in the slab waveguide and connected to the input waveguide; and an output guide gate disposed in the slab waveguide and connected to the output waveguide;
wherein the echelle grating filter extends in a first direction and has curvature;
wherein the echelle grating filter has gratings of sawtooth shape; and
wherein an angle formed by the gratings of the sawtooth shape is greater than 90 degrees and less than 180 degrees.

10. The optical waveguide device of claim 9, wherein the output waveguide includes a plurality of output waveguides; and
wherein the output guide gate includes a plurality of output guide gates.

11. The optical waveguide device of claim 9, wherein the input and output guide gates are disposed toward the echelle grating filter.

12. The optical waveguide device of claim 9, wherein the input waveguide and the output waveguide extend in the first direction.

13. The optical waveguide device of claim 9, wherein the input guide gate is disposed toward a center of the echelle grating filter.

14. The optical waveguide device of claim 9, wherein the input and output waveguides, the input and output guide gates and the slab waveguide include the same material.

15. The optical waveguide device of claim 9, wherein the input and output waveguides, the input and output guide gates and the slab waveguide include silicon.

16. The optical waveguide device of claim 9, further comprising:
a cladding layer covering the input waveguide part, the output waveguide part, and the filter part.

17. The optical waveguide device of claim 16, wherein the cladding layer and the echelle grating filter include the same material.

18. The optical waveguide device of claim 16, wherein the cladding layer and the echelle grating filter include silicon oxide.
